(19) United States
(12) Patent Application Publication
(10) Pub. No.: US 2025/0129498 A1
(43) Pub. Date: Apr. 24, 2025

(54) ELECTRODE FOR CARBON DIOXIDE REDUCTION REACTION INCLUDING TRIAZINE COVALENT ORGANIC FRAMEWORK NANOFILM AND MANUFACTURING METHOD THEREOF

(71) Applicant: KOREAN ADVANCED INSTITUTE OF SCIENCE AND TECHNOLOGY, Daejeon (KR)

(72) Inventors: Hye Ryung BYON, Daejeon (KR); Yusik OH, Daejeon (KR)

(21) Appl. No.: 18/781,055

(22) Filed: Jul. 23, 2024

(30) Foreign Application Priority Data
Jul. 25, 2023 (KR) 10-2023-0096858

(51) Int. Cl. C25B 11/085; C08G 12/30; C08J 5/12; C25B 3/26; C25B 9/19; C25B 11/054

(52) U.S. Cl. CPC C25B 11/085; C08G 12/30; C08J 5/12; C25B 9/19; C25B 11/054; C08J 2361/26; C25B 3/26

(57) ABSTRACT

Provided is an electrode for a carbon dioxide reduction reaction which produces a multi-carbon compound using a carbon dioxide reduction reaction, and more particularly, a high-efficiency electrode for a carbon dioxide reduction reaction having high multi-carbon compound selectivity with significantly fewer side reactions such as a hydrogen evolution reaction, a method for manufacturing the same, and a carbon dioxide electric reduction device using the electrode for a carbon dioxide reduction reaction are provided.

### CROSS-REFERENCE TO RELATED APPLICATIONS

This application claims priority under 35 U.S.C. § 119 to Korean Patent Application No. 10-2023-0096858, filed on Jul. 25, 2023, in the Korean Intellectual Property Office, the disclosure of which is incorporated herein by reference in its entirety.

### TECHNICAL FIELD

The following disclosure relates to an electrode for a carbon dioxide reduction reaction which produces a multi-carbon compound using a carbon dioxide reduction reaction, and more particularly, to a high-efficiency electrode for a carbon dioxide reduction reaction having high multi-carbon compound selectivity with significantly fewer side reactions such as a hydrogen evolution reaction, a method for manufacturing the same, and a carbon dioxide electric reduction device using the electrode for a carbon dioxide reduction reaction.

### BACKGROUND

The accumulation of greenhouse gases such as carbon dioxide in the air produced by the combustion of fossil fuels is causing serious environmental problems such as global warming, and research to solve the problems has been conducted worldwide for the past several decades.

Therefore, research on decomposing carbon dioxide (CO₂) to convert it into high value-added materials such as ethylene and carbon monoxide is in the spotlight. As a part of the research, there is a carbon dioxide electroreduction reaction in which carbon dioxide is decomposed by a direct electrochemical method under the conditions of pH neutral environment, atmospheric pressure, and low temperature. Though the carbon dioxide electroreduction reaction has a simple process and is economical, due to the problems such as low selectivity and low reactivity of the high value-added materials when the electroreduction reaction is carried out using a common electrode, development of an electrode including various catalysts, and the catalyst is progressing steadily.

A copper (Cu)-based electrode is known as the only metal-based electrochemical catalyst which may produce a high value-added multi-carbon compound. However, since products due to various side reactions are produced simultaneously on a copper electrode, the selectivity and reactivity of a specific high value-added multi-carbon compound such as ethylene and ethanol are low, and a hydrogen evolution reaction is accompanied in a water-based electrolyte.

Therefore, there is a need for development of a high-efficiency electrode for carbon dioxide electroreduction reaction which suppresses a hydrogen evolution reaction while having high selectivity and reactivity of a specific high value-added multi-carbon compound such as ethylene and ethanol.

### SUMMARY

An embodiment of the present invention is directed to providing a high-efficiency electrode for a carbon dioxide reduction reaction which has high selectivity and reactivity of a multi-carbon compound and low selectivity of a side reaction during a carbon dioxide electroreduction reaction, and a method for manufacturing the same.

Another embodiment of the present invention is directed to providing a carbon dioxide electroreduction device which produces a multi-carbon compound using the electrode for a carbon dioxide reduction reaction.

In one general aspect, a method for manufacturing an electrode for a carbon dioxide reduction reaction includes: laminating a triazine structure thin film which is prepared by condensation polymerization of an amine-substituted triazine compound and an aldehyde compound on a copper substrate, wherein the condensation polymerization is performed by light irradiation.

In the method for manufacturing an electrode for a carbon dioxide reduction reaction, the triazine structure thin film may be prepared by (S1) dropping a mixed solution including the amine-substituted triazine compound and the aldehyde compound onto a surface of a solvent to form a mixed solution film on the surface of the solvent; and (S2) irradiating the mixed solution film with light to manufacture the triazine structure thin film.

In the method for manufacturing an electrode for a carbon dioxide reduction reaction, the laminating may be performed by transferring the triazine structure thin film placed on the surface of the solvent.

In the method for manufacturing an electrode for a carbon dioxide reduction reaction, the amine-substituted triazine compound may be a compound satisfying the following Chemical Formula 1:

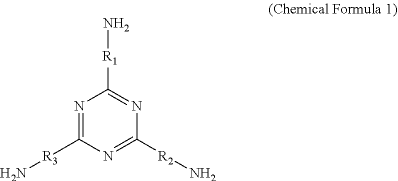

wherein R₁ to R₃ are independently of one another alkylene having 2 to 8 carbon atoms or arylene.

In the method for manufacturing an electrode for a carbon dioxide reduction reaction, the amine-substituted triazine compound may be 1,3,5-tris (4-aminophenyl)triazine).

In the method for manufacturing an electrode for a carbon dioxide reduction reaction, the aldehyde compound may satisfy the following Chemical Formula 2:

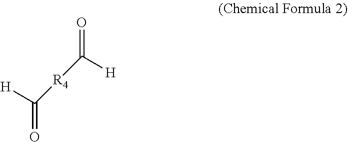

wherein R₄ is alkylene having 2 to 8 carbon atoms or arylene.

In the method for manufacturing an electrode for a carbon dioxide reduction reaction, R₄ of Chemical Formula 2 may be phenylene.

In the method for manufacturing an electrode for a carbon dioxide reduction reaction, the mixed solution of (S1) may further include acetic acid.

In the method for manufacturing an electrode for a carbon dioxide reduction reaction, the light of (S2) may be light in a wavelength band of 350 to 850 nm.

In the method for manufacturing an electrode for a carbon dioxide reduction reaction, the triazine structure thin film may have a thickness of 2 nm to 50 nm.

In another general aspect, an electrode for a carbon dioxide reduction reaction manufactured by the method described above is provided.

In the electrode for a carbon dioxide reduction reaction according to the present invention, a surface of the electrode for a carbon dioxide reduction reaction may have a water contact angle of 90° or more.

In still another general aspect, a carbon dioxide electroreduction device includes: an electrode for a carbon dioxide reduction reaction manufactured by one of the methods for manufacturing an electrode for a carbon dioxide reduction reaction described above; an anion exchange membrane; a counter electrode separated from the electrode for a carbon dioxide reduction reaction; and an electrolyte, wherein the anion exchange membrane is placed between the electrode for a carbon dioxide reduction reaction and the counter electrode, and a multi-carbon compound is produced from carbon dioxide by an electroreduction reaction.

In the carbon dioxide electroreduction device according to the present invention, the multi-carbon compound may be one or more selected from the group consisting of ethylene, ethanol, and a combination thereof.

In the carbon dioxide electroreduction device according to the present invention, the ethylene produced by the electroreduction reaction may have a Faradaic efficiency (FE) of 20% or more at −1.1 V using a reversible hydrogen electrode (RHE) as a reference electrode.

In the carbon dioxide electroreduction device according to the present invention, the hydrogen (H₂) produced by the electroreduction reaction may have a Faradaic efficiency (FE) of 20% or less at −1.1 V using the reversible hydrogen electrode (RHE) as a reference electrode.

Other features and aspects will be apparent from the following detailed description, the drawings, and the claims.

### BRIEF DESCRIPTION OF THE DRAWINGS

FIG. 1 is a drawing schematically showing the method for manufacturing an electrode for a carbon dioxide reduction reaction according to the present invention.

FIG. 2 is a drawing schematically showing a structure of the triazine structure (trCOF) according to an exemplary embodiment of the present invention.

FIG. 3 is a drawing showing a surface of the electrode for a carbon dioxide reduction reaction according to Example 1 analyzed by a scanning electron microscope (SEM).

FIG. 4 is a drawing showing the surface of the electrode for a carbon dioxide reduction reaction according to Example 1 analyzed by an atomic force microscope (AFM).

FIG. 5 is a drawing showing a scanning electron microscopic top-view image of the electrode for a carbon dioxide reduction reaction according to Example 2.

FIG. 6 is a drawing showing a scanning electron microscopic cross-sectional image of the electrode for a carbon dioxide reduction reaction according to Example 2.

FIG. 7 is a drawing showing the electrode for a carbon dioxide reduction reaction according to Example 1 analyzed by grazing incidence X-ray diffraction (GIXRD).

FIG. 8 is a drawing showing the electrode for a carbon dioxide reduction reaction according to Example 1 analyzed using Fourier transform infrared (FT-IR) spectroscopy.

FIG. 9 is a drawing showing the structure of the triazine structure thin film placed on the electrode for a carbon dioxide reduction reaction according to Example 1 which is analyzed using Pawley refinement.

FIG. 10 is drawings showing measured partial current density of a carbon dioxide electroreduction system including the electrodes for carbon dioxide reduction reaction according to Example 1 (trCOF-Cu) and Comparative Example 1 (Cu).

FIG. 11 is drawings showing Faradaic efficiency (FE) of the carbon dioxide electroreduction system including the electrodes for carbon dioxide reduction reaction according to Example 1 (trCOF-Cu) and Comparative Example 1 (Cu).

FIG. 12 is drawings showing measured Faradaic efficiency by time of the electrodes for carbon dioxide reduction reaction according to Example 1 (trCOF-Cu) and

### Comparative Example 1 (Cu)

FIG. 13 is drawings showing the electrode for a carbon dioxide reduction reaction according to Example 1 after carrying out an electroreduction reaction at −1.05 V based on a reversible hydrogen electrode for 2 hours, which is measured using X-ray photoelectron spectroscopy (XPS).

FIG. 14 is a drawing showing a measured water contact angle of the surface of the electrode for a carbon dioxide reduction reaction according to Example 1.

FIG. 15 is a drawing showing a measured electric double layer capacitance of the electrode for a carbon dioxide reduction reaction according to Example 1.

FIG. 16 is drawings showing results of measuring a real-time infrared absorption spectrum of the surface of the electrodes for carbon dioxide reduction reaction according to Example 1 (trCOF-Cu) and Comparative Example 1 (Cu), while carrying out an electroreduction reaction in the carbon dioxide electroreduction system.

FIG. 17 is a drawing showing a measured carbon dioxide adsorption capacity of the electrodes for carbon dioxide reduction reaction according to Example 1 (m-trCOF) and Comparative Example 1 (m-tr-free COF).

FIG. 18 is drawings of behaviors of carbon monoxide (Co) intermediates adsorbed on the surface of the electrodes for carbon dioxide reduction reaction according to Example 1 (trCOF-Cu) and Comparative Example 1 (Cu) which were compared and analyzed by a real-time infrared absorption spectrum and then shown on the left (trCOF-Cu; Example 1) and right (Cu; Comparative Example 1) of FIG. 18.

FIG. 19 is drawings showing Faradaic efficiency of each chemical species of a carbon dioxide electroreduction reaction carried out by a carbon dioxide reduction reaction system including the electrodes for carbon dioxide reduction reaction according to Example 1 (trCOF-Cu (t=4 nm)) and Example 2 (thick trCOF-Cu (t=27 nm)).

### DETAILED DESCRIPTION OF EMBODIMENTS

The embodiments described in the present specification may be modified in many different forms, and the technology according to an exemplary embodiment is not limited to the embodiments set forth herein. In addition, the embodiments of an exemplary embodiment are provided so that the present disclosure will be described in more detail to a person with ordinary skill in the art. Technical terms and scientific terms used herein have the general meaning commonly understood by a person skilled in the art to which the present disclosure pertains unless otherwise defined, and description for the known function and configuration which may unnecessarily obscure the gist of the present disclosure will be omitted in the following description and the accompanying drawings.

In addition, the singular form used in the present specification and the claims appended thereto may be intended to include a plural form also, unless otherwise indicated in the context.

In addition, in the present specification and the appended claims, the terms such as “first” and “second” are not used in a limited meaning but are used for the purpose of distinguishing one constituent element from other constituent elements.

In addition, in the present specification and the appended claims, when it is said that a part such as a film (layer), a domain, or a constituent element is positioned “on”, “in the upper portion”, “in the upper stage”, “under”, “in the lower portion”, or “in the lower stage”, it includes not only the case in which one part is in contact with the other part, but also the case in which there is another part between two parts.

In addition, the terms “about”, “substantially”, and the like used in the present specification and the appended claims are used in the meaning of the numerical value or in the meaning close to the numerical value when unique manufacture and material allowable errors are suggested in the mentioned meaning, and are used for preventing the disclosure mentioning a correct or absolute numerical value for better understanding of the present specification and the attached claims from being unfairly used by an unconscionable infringer.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms.

Furthermore, in the present specification and the appended claims, the terms such as “comprise” or “have” mean that there is a characteristic or a constituent element described in the specification, and as long as it is not particularly limited, a possibility of adding one or more other characteristics or constituent elements is not excluded in advance.

Hereinafter, the electrode for a carbon dioxide reduction reaction, the method for manufacturing an electrode for a carbon dioxide reduction reaction, and the carbon dioxide electroreduction device will be described in detail.

The present invention provides a method for manufacturing an electrode for a carbon dioxide reduction reaction, and the method for manufacturing a carbon dioxide reduction reaction includes: laminating a triazine structure thin film which is prepared by condensation polymerization of an amine-substituted triazine compound and an aldehyde compound on a copper substrate, wherein the condensation polymerization is performed by light irradiation.

According to an exemplary embodiment, the amine-substituted triazine compound may be a compound satisfying the following Chemical Formula 1:

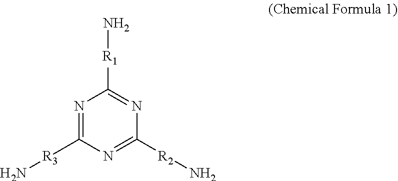

wherein R₁ to R₃ are independently of one another alkylene having 2 to 8 carbon atoms or arylene.

The triazine included in the amine-substituted triazine compound may have high selectivity for a multi-carbon compound by increasing concentrations of carbon dioxide on the surface of the copper substrate and carbon monoxide which is a reaction intermediate. In addition, when the triazine compound is bonded on the copper substrate, the water contact angle is greatly increased as compared with a common copper substrate, so that an electric double layer capacitance may be decreased. This means that the active surface area of the surface of the copper substrate is decreased by the triazine compound, and thus, a hydrogen evolution reaction which is a side reaction may be decreased.

According to an exemplary embodiment, the aldehyde compound may be a compound satisfying the following Chemical Formula 2:

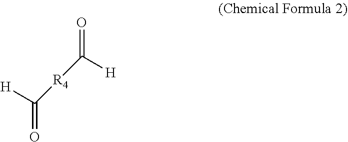

wherein R₄ is alkylene having 2 to 8 carbon atoms or arylene.

The aldehyde included in the aldehyde compound may be condensation-polymerized with an amine included in the amine-substituted triazine compound to produce a triazine structure thin film, that is, a covalent organic framework.

As a non-limiting example, the triazine compound may be 1,3,5-tris (4-aminophenyl)triazine, and since the aldehyde compound may be terephthalaldehyde of Chemical Formula 2 wherein R₄ is phenylene, an amine group included in the 1,3,5-tris (4-aminophenyl)triazine and an aldehyde group included in the terephthalaldehyde are condensation-polymerized to produce a covalent organic framework in which the structural unit as in FIG. 2 is repeated. The covalent organic framework may have pores of a certain size due to high crystallinity, and the selectivity and reactivity of the multi-carbon compound may vary depending on the pore size.

According to an exemplary embodiment, the pore size of the covalent organic framework may vary depending on the functional groups of R₁ to R₃ included in the triazine compound of Chemical Formula 1; and the functional group of R₄ included in the aldehyde compound of Chemical Formula 2. The pore size of may be 1 nm or more, 2 nm or more, or 3 nm or more and, as the upper limit, 20 nm or less, 10 nm or less, or 5 nm or less. Specifically, it may be 1 to 20 nm, 2 to 10 nm, or 3 to 5 nm.

As a favorable example for increasing selectivity of ethylene which is an example of the multi-carbon compound, the triazine compound may be 1,3,5-tris (4-aminophenyl)triazine, and the aldehyde compound may be terephthalaldehyde, and thus, pore size may be about 3.3 nm. The pore size may be adjusted by appropriately selecting the functional groups of R₁ to R₃ and R₄ depending on the use purpose of the electrode for a carbon dioxide reduction reaction within the range described above.

The wavelength band and the intensity of light irradiated for the condensation polymerization may vary depending on the triazine compound, the aldehyde compound, and an additive which is further added for the condensation polymerization.

According to an exemplary embodiment, the wavelength band of the light may be 300 nm or more, 350 nm or more, 400 nm or more, or 450 nm or more and, as the upper limit, 900 nm or less, 850 nm or less, 800 nm or less, or 750 nm or less. Specifically, it may be 300 to 900 nm, 350 to 850 nm, 400 to 800 nm, or 450 to 750 nm. As a favorable example, the wavelength band of the light may be a wavelength band in a visible light region and sunlight may be used as a light source.

According to an exemplary embodiment, the intensity of the light irradiated for the condensation polymerization may be appropriately adjusted depending on a reaction time and a reaction degree to be desired in the condensation polymerization. The light intensity may be 500 W/m2 or more, 650 W/m2 or more, or 800 W/m2 or more and as the upper limit, 2000 W/m2 or less. Specifically, it may be 500 to 2000 W/m2, 650 to 2000 W/m2, or 800 to 2000 W/m2, but the present invention is not limited to the light intensity, and the light may be selected in the level of intensity with low processing costs without decomposing the triazine compound, the aldehyde compound, the additive, and the covalent organic framework.

According to an exemplary embodiment, the triazine structure thin film may be prepared by (S1) dropping a mixed solution including the amine-substituted triazine compound and the aldehyde compound onto a surface of a solvent to form a mixed solution film on the surface of the solvent; and (S2) irradiating the mixed solution film with light to manufacture a triazine structure thin film.

The solvent of (S1) may be any solvent as long as it has a higher specific gravity than the mixed solution including the triazine compound and the aldehyde compound, is not mixed with its different polarity, and does not react with the triazine compound and the aldehyde compound. As a favorable example, the solvent may be water (H₂O). Since the specific gravity of the solvent is higher than the mixed solution and is not mixed with its different polarity, when the mixed solution is dropped onto the solvent, the mixed solution may be placed in a thin film form, that is, a mixed solution film form on the surface of the solvent.

According to an exemplary embodiment, in the dropping of (S1), a dropping amount of the mixed solution may be appropriately selected depending on the size of a container containing the solvent. The dropping amount may be an amount to form the mixed solution thickness of 1 nm or more, 2 nm or more, 3 nm or more, 5 nm or more, 10 nm or more, 20 nm or more, or 30 nm or more and, as the upper limit, 100 nm or less or 50 nm or less. Specifically, the dropping amount may be an amount to form the mixed solution thickness of 1 to 100 nm, 2 to 100 nm, 3 to 50 nm, 5 to 50 nm, 10 to 50 nm, 20 to 50 nm, or 30 to 50 nm. The thickness of the mixed solution film may be proportional to the thickness of the triazine structure thin film prepared after carrying out (S2). Since the selectivity, the reactivity, and the like of the multi-carbon compound may vary depending on the thickness of the triazine structure thin film, the thickness of the mixed solution film may be appropriately selected depending on the use purpose and the use environment of the electrode for a carbon dioxide reduction reaction within the range described above.

According to an exemplary embodiment, the mixed solution of (S1) may further include one or more chemical species selected from the group consisting of acetic acid, p-toluenesulfonic acid (PTSA), scandium (III) triflate (Sc(OTf) 3), and pyrrolidine. The mixed solution may include the chemical species described above to initiate and promote the condensation reaction of the triazine compound and the aldehyde compound.

According to an exemplary embodiment, the mixed solution of (S1) may further include acetic acid and chloroform. Ratios of the acetic acid and the chloroform which are further included in the mixed solution of (S1) may be appropriately adjusted to appropriately adjust the polarity of the mixed solution, the uniformity of the thickness of the mixed solution film may be increased depending on the polarity, and the mixed solution film may be uniformly maintained even at a small thickness.

According to an exemplary embodiment, the electrode for a carbon dioxide reduction reaction may be manufactured by transferring the triazine structure thin film prepared by the process described above onto the copper substrate. Since the triazine structure thin film may be polymerized and placed on the surface of the solvent, the electrode for a carbon dioxide reduction reaction may be manufactured by a transfer method of lifting the copper substrate under the triazine structure thin film.

The present invention provides an electrode for a carbon dioxide reduction reaction, and the electrode for a carbon dioxide reduction reaction is manufactured using the method for manufacturing an electrode for a carbon dioxide reduction reaction described above. In the description of the electrode for a carbon dioxide reduction reaction, since a triazine compound, an aldehyde compound, a triazine structure, a copper substrate, and the like are the same as or similar to those described in the method for manufacturing an electrode for a carbon dioxide reduction reaction described above, the electrode for a carbon dioxide reduction reaction according to the present invention includes all descriptions in the method for manufacturing an electrode for a carbon dioxide reduction reaction above.

Hereinafter, the electrode for a carbon dioxide reduction reaction of the present invention will be described in detail.

According to an exemplary embodiment, the surface of the electrode for a carbon dioxide reduction reaction may have a water contact angle of 90° or more. Since the triazine structure is placed on the surface of the electrode for a carbon dioxide reduction reaction, the triazine structure thin film is hydrophobic and may have a water contact angle of 90° or more. The water contact angle of the electrode for a carbon dioxide reduction reaction may be 70° or more, 80° or more, 90° or more, or 100° or more and, as the upper limit, 140° or less, 130° or less, 120° or less, or 110° or less. Specifically, the water contact angle on the surface of the electrode for a carbon dioxide reduction reaction may be 70 to 140°, 80 to 130°, 90 to 120°, or 100 to 110°.

The present invention provides a carbon dioxide electroreduction device, and the carbon dioxide electroreduction device includes: the electrode for a carbon dioxide reduction reaction described above; an anion exchange membrane; a counter electrode separated from the electrode for a carbon dioxide reduction reaction; and an electrolyte, wherein the anion exchange membrane is placed between the electrode for a carbon dioxide reduction reaction and the counter electrode, and a multi-carbon compound is produced from carbon dioxide by an electroreduction reaction.

In the description of the carbon dioxide electroreduction device, since the carbon dioxide electroreduction device includes the electrode for a carbon dioxide reduction reaction described above, the carbon dioxide electroreduction device according to the present invention includes all descriptions of the method for manufacturing an electrode for a carbon dioxide reduction reaction and the electrode for a carbon dioxide reduction reaction above.

Hereinafter, the carbon dioxide electroreduction device of the present invention will be described in detail.

The counter electrode is an electrode which serves to complete an electrical circuit so that charges move in the carbon dioxide electroreduction device to cause an oxidation reduction reaction, and may be any electrode as long as it may be used as a counter electrode of the electrode for a carbon dioxide reduction reaction. As a non-limiting example, the counter electrode may be a reversible hydrogen electrode (RHE).

The anion exchange membrane may be placed between the electrode for a carbon dioxide reduction reaction and the counter electrode as a conductive path of an anion when carrying out the electroreduction reaction for the carbon dioxide reduction reaction. The anion exchange membrane may be any anion exchange membrane which may be used as an anion conductive path and is commonly used in the art.

The electrolyte may be used as an ion conductive path of the electrode for a carbon dioxide reduction reaction and the counter electrode when the electroreduction reaction is carried out in the carbon dioxide electroreduction device. The electrolyte may support all or part of the electrode for a carbon dioxide reduction reaction, the counter electrode, and the anion exchange membrane to carry out the electroreduction reaction. The electrolyte may be any electrolyte which is commonly used as an electrolyte in the art.

The multi-carbon compound may be a carbon-based chemical species produced from the electroreduction reaction of the carbon dioxide electroreduction device. The multi-carbon compound may be one or more chemical species selected from the group consisting of multi-carbon compounds such as ethylene (C₂H4), ethanol (C₂H₅OH), allyl alcohol, ethylene glycol, n-propanol, glycolaldehyde, acetone, hydroxyacetone, acetate, acetaldehyde, and propionaldehyde.

According to an exemplary embodiment, the multi-carbon compound produced from carbon dioxide by an electroreduction reaction in the carbon dioxide electroreduction device may be one or more selected from the group consisting of ethylene, ethanol, and a combination thereof. The ethylene and the ethanol are high value-added multi-carbon compounds, and the carbon dioxide electroreduction device including the electrode for a carbon dioxide reduction reaction may have high selectivity for ethylene and ethanol.

According to an exemplary embodiment, the Faradaic efficiency (FE) of ethylene produced by the electroreduction reaction in the carbon dioxide electroreduction device may be 20% or more at −1.1 V using a reversible hydrogen electrode (RHE) as a reference electrode. The carbon dioxide electroreduction device may produce ethylene as described above, and since the carbon dioxide electroreduction device includes the electrode for a carbon dioxide reduction reaction, it may have high selectivity for the multi-carbon compound during the electroreduction reaction. Specifically, the Faradaic efficiency of ethylene produced by the electroreduction reaction of the carbon dioxide electroreduction device may be 10% or more, 15% or more, 20% or more, or 25% or more and as the upper limit, 45% or less, 40% or less, or 35% or less at −1.1 V, when the counter electrode is a reversible hydrogen electrode. Specifically, it may be 10 to 458, 15 to 40%, or 20 to 35%.

According to an exemplary embodiment, the Faradaic efficiency (FE) of hydrogen (H₂) produced by the electroreduction reaction may be 20% or less at −1.1 V using the reversible hydrogen electrode (RHE) as a reference electrode. Specifically, the Faradaic efficiency of hydrogen produced by the electroreduction reaction of the carbon dioxide electroreduction device may be 40% or less, 30% or less, or 20% or less and as the lower limit, 1% or more, 5% or more, or 10% or more at −1.1 V, when the counter electrode is a reversible hydrogen electrode. Specifically, it may be 1 to 40%, 5 to 30%, or 10 to 20%.

Hereinafter, the examples and the experimental examples will be illustrated specifically in detail in the following. However, the examples and the experimental examples described later are only a partial illustration, and the technology described in the present specification is not construed as being limited thereto.

### Example 1

7 mg of 1,3,5-tris-(4-aminophenyl)triazine (TAPT) and 4 mg of terephthalaldehyde (TA) were added to and dissolved in 8 ml of a mixed solvent of 1,4-dioxane, 1,3,5-trimethylbenzene, and chloroform at a volume ratio of 1:1:2, and then 0.6 ml of acetic acid was further added to the mixed solvent to prepare a mixed solution.

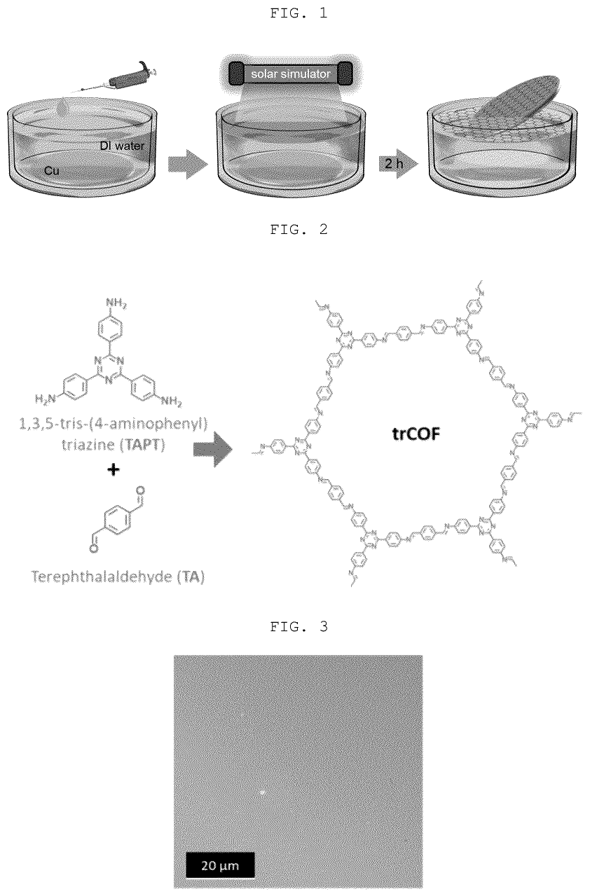

As shown in FIG. 1, a copper substrate and deionized water were added to a bath, 10 μl of the mixed solution was dropped onto the surface of the deionized water to form a mixed solution film on the surface of the deionized water (left side of FIG. 1).

The mixed solution film was irradiated with sunlight for 2 hours to carry out the condensation reaction of 1,3,5-tris-(4-aminophenyl)triazine and terephthalate included in the mixed solution film to prepare a triazine structure thin film (middle side of FIG. 1). The structure of the triazine structure (trCOF) is shown in the right side of FIG. 2.

The copper substrate placed in the lower portion of the bath was lifted so that the triazine structure thin film was placed on the surface of the copper substrate, thereby manufacturing the electrode for a carbon dioxide reduction reaction (right side of FIG. 1.).

### Example 2

An electrode for a carbon dioxide reduction reaction was manufactured in the same manner as in Example 1, except that 50 μl of the mixed solution was dropped onto the surface of the deionized water to form a mixed solution film.

### Comparative Example 1

The copper substrate of Example 1 was used as an electrode for a carbon dioxide reduction reaction.

### Comparative Example 2

An electrode for a carbon dioxide reduction reaction was used in the same manner as in Example 1, except that 1,3,5-tris (4-aminophenyl)benzene (TAPB) was used instead of 1,3,5-tris-(4-aminophenyl)triazine (TAPT).

### Experimental Example 1

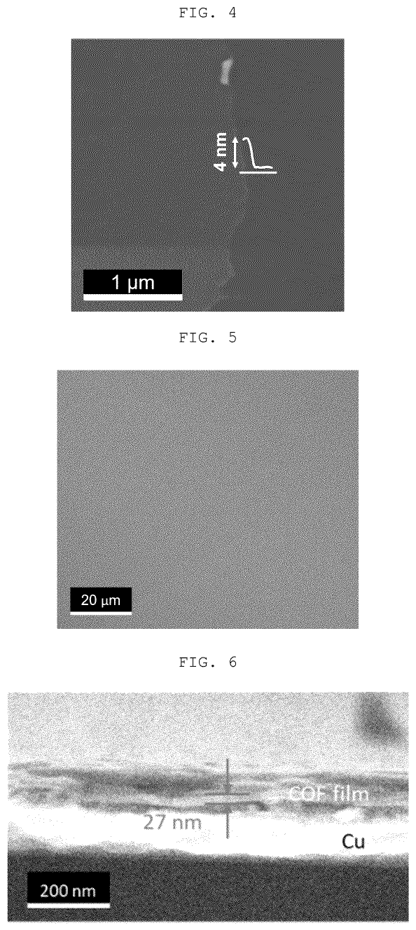

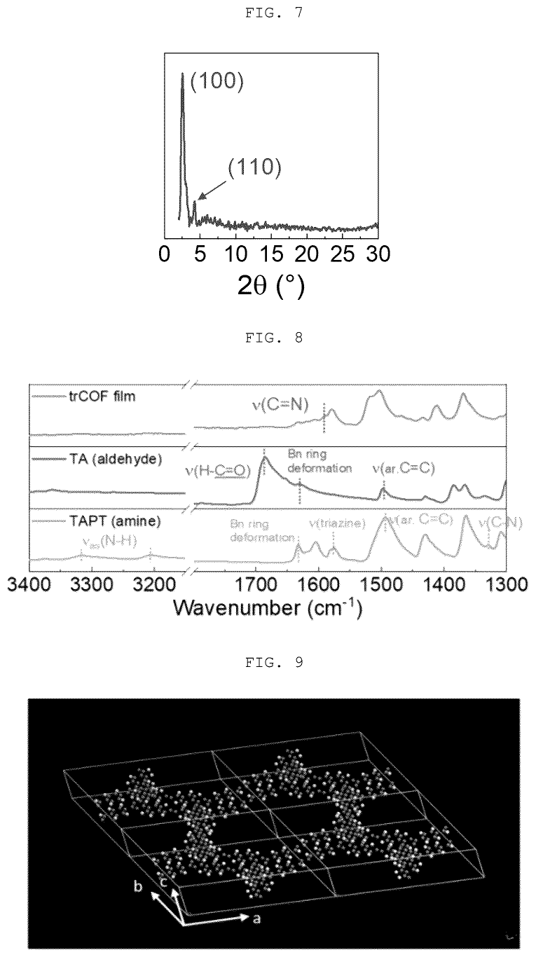

The surface of the electrode for a carbon dioxide reduction reaction according to Example 1 was analyzed with a scanning electron microscope (SEM) and an atomic force microscopy (AFM) and the results are shown in FIGS. 3 and 4, respectively. Referring to FIG. 4, it was confirmed that a triazine structure thin film having a thickness of about 4 nm was laminated on the surface of the electrode for a carbon dioxide reduction reaction according to Example 1.

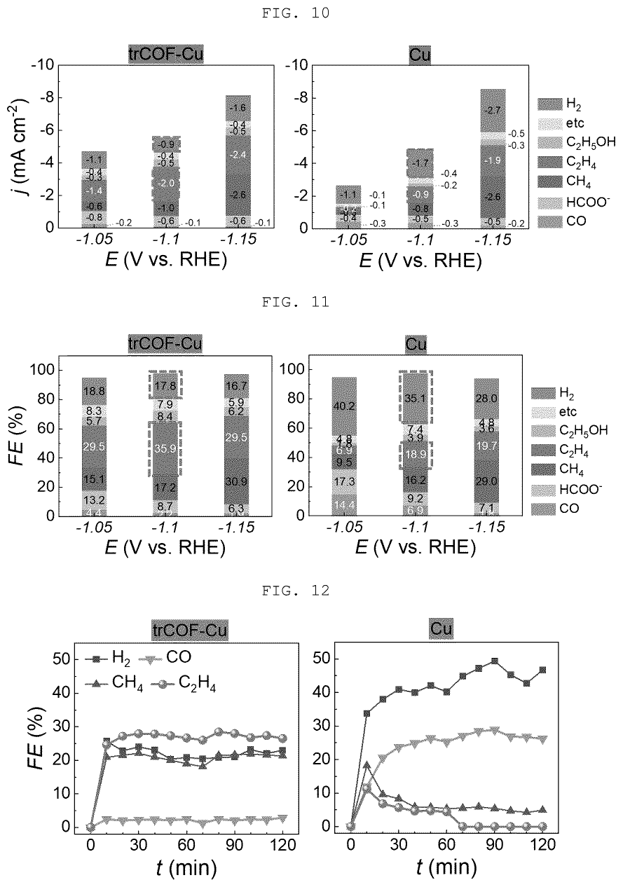

In addition, a top-view image and a cross-sectional image of the surface of the electrode for a carbon dioxide reduction reaction according to Example 2 by scanning electron microscopy are shown in FIGS. 5 and 6, respectively. Referring to FIG. 5, it was confirmed that a triazine structure thin film having a thickness of about 27 nm was laminated on the surface of the electrode for a carbon dioxide reduction reaction according to Example 2.

### Experimental Example 2

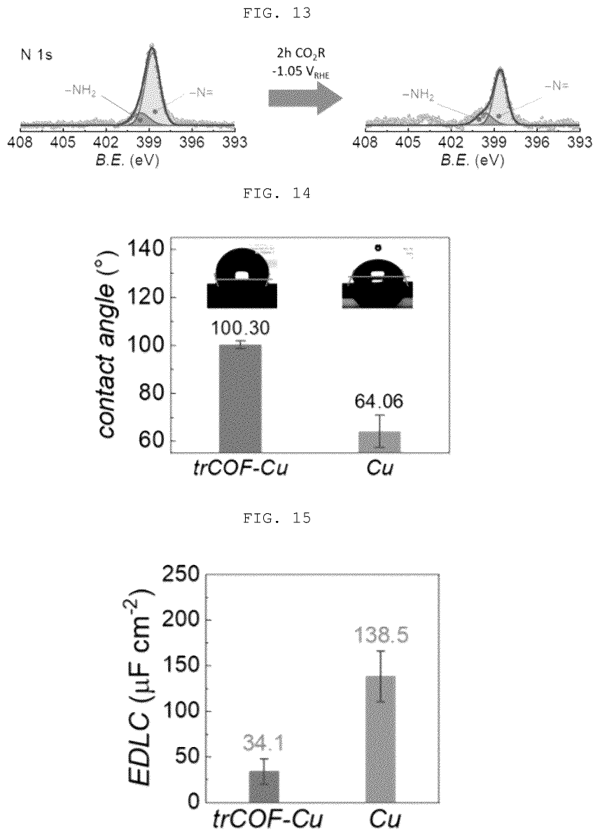

The electrode for a carbon dioxide reduction reaction according to Example 1 was analyzed by grazing incidence X-ray diffraction (GIXRD), and the results are shown in FIG. 7.

It was confirmed that the triazine structure thin film placed on the copper substrate of Example 1 had high crystallinity.

### Experimental Example 3

The electrode for a carbon dioxide reduction reaction according to Example 1 was analyzed using Fourier transform infrared (FT-IR) spectroscopy and the results are shown in FIG. 8.

It was confirmed that the triazine structure thin film (trCOF film) placed on the electrode for a carbon dioxide reduction reaction was a thin film prepared by a condensation reaction of 1,3,5-tris-(4-aminophenyl)triazine (TAPT) and terephthalaldehyde (TA).

### Experimental Example 4

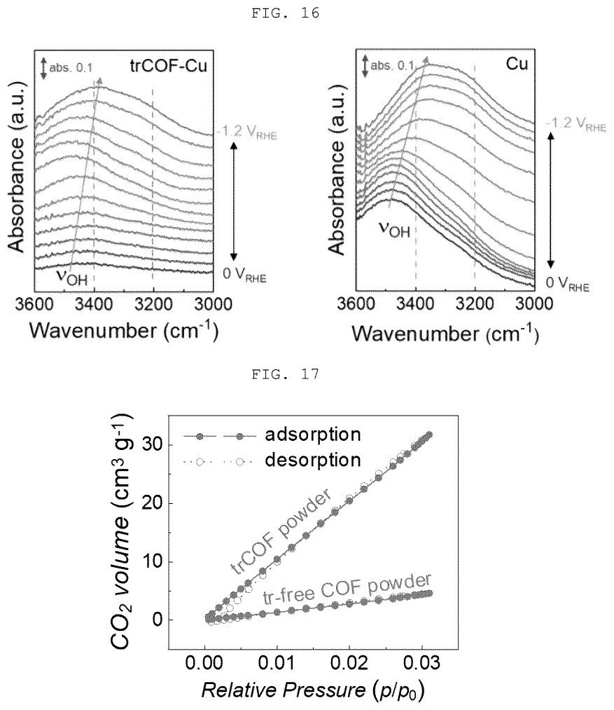

The structure of the triazine structure thin film placed on the electrode for a carbon dioxide reduction reaction according to Example 1 was analyzed using Pawley refinement and is shown in FIG. 9.

It was confirmed that the triazine structure thin film had a pore size of about 3.3 nm.

### Experimental Example 5

A carbon dioxide electroreduction system including the electrode for a carbon dioxide reduction reaction according to Example 1 (trCOF-Cu) and Comparative Example 1 (Cu); an anion exchange membrane (Selemion AMV-N); an electrolyte (KHCO₃), a platinum foil counter electrode, and a Ag/AgCl reference electrode was manufactured. An electrolyte saturated with carbon dioxide was used as the electrolyte, and gaseous carbon dioxide was continuously supplied to both electrolyte chambers interposed between the anion exchange membrane at 20 ml/min. A gaseous product produced by the reduction reaction was measured by gas chromatography (GC), and a liquid product was analyzed by nuclear magnetic resonance spectroscopy (NMR). Furthermore, the Faradaic efficiency of the product was calculated by comparing the measured amount of each product and the measured amount of charges consumed during electrolysis.

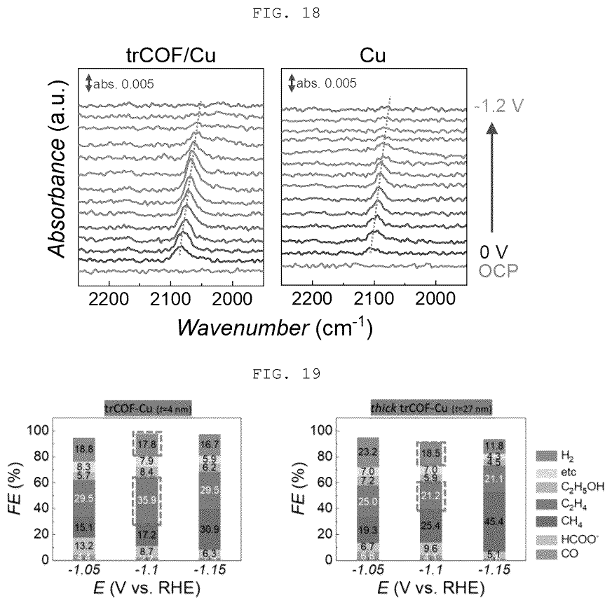

The partial current density and the Faradaic efficiency (FE) of the carbon dioxide electroreduction system of the carbon dioxide electroreduction reaction depending on the applied voltage of the electrode for a carbon dioxide reduction reaction are shown in FIGS. 10 and 11, respectively.

Referring to FIG. 10, it was confirmed that the electrode for a carbon dioxide reduction reaction according to Example 1 (trCOF-Cu) had a partial current density of a multi-carbon compound (C₂H₄, C₂H₅OH, etc.) reaching −2.9 mA/cm² under the condition of −1.1 V as compared with a reversible hydrogen electrode (RHE), but the electrode for a carbon dioxide reduction reaction according to Comparative Example 1 (Cu) had a partial current density of a multi-carbon compound (C₂H₄, C₂H₅OH, etc.) of only −1.5 mA/cm² under the conditions of −1.1 V as compared with a reversible hydrogen electrode (RHE).

In addition, referring to FIG. 11, it was confirmed that the electrode for a carbon dioxide reduction reaction according to Example 1 (trCOF-Cu) had a Faradaic efficiency of a multi-carbon compound (C₂H₄, C₂H₅OH, etc.) reaching 53% under the condition of −1.1 V as compared with a reduction reaction (RHE), but the electrode for a carbon dioxide reduction reaction according to Comparative Example 1 (Cu) had a Faradaic efficiency of a multi-carbon compound (C₂H₄, C₂H₅OH, etc.) of only 30% under the condition of −1.1 V as compared with a reversible hydrogen electrode (RHE).

### Experimental Example 6

The Faradaic efficiency by time of the electrodes for carbon dioxide reduction reaction according to Example 1 (trCOF-Cu) and Comparative Example 1 (Cu) was measured using the carbon dioxide electroreduction system and is shown in FIG. 12.

It was confirmed that the produced amounts of ethylene (C₂H₄), methane (CH₄), hydrogen (H₂), and carbon monoxide (CO) of the carbon dioxide electroreduction system including the electrode for a carbon dioxide reduction reaction according to Example 1 were constant over time, while in the case of the produced amounts of ethylene (C₂H₄), methane (CH₄), hydrogen (H₂), and carbon monoxide (CO) of the carbon dioxide electroreduction system including the electrode for a carbon dioxide reduction reaction according to Comparative Example 1, production of ethylene and methane was rapidly deactivated within 1 hour and the produced amounts of hydrogen and carbon monoxide were increased. That is, it was confirmed that the electrode for a carbon dioxide reduction reaction according to Example 1 had higher catalytic stability as compared with the electrode for a carbon dioxide reduction reaction of Comparative Example 1.

### Experimental Example 7

In order to confirm the stability of the electrode for a carbon dioxide reduction reaction according to Example 1, an electroreduction reaction was carried out at −1.05 V based on a reversible hydrogen electrode for 2 hours, using the electrode for a carbon dioxide reduction reaction according to Example 1. The electrode for a carbon dioxide reduction reaction was measured using X-ray photoelectron spectroscopy (XPS) and is shown in FIG. 13.

Referring to FIG. 13, it was confirmed that the electrode for a carbon dioxide reduction reaction according to Example 1 maintained the properties even after the electroreduction reaction under the above conditions.

### Experimental Example 8

In order to confirm the resolution of the electrode for a carbon dioxide reduction reaction according to Example 1, the surface water contact angle and the electric double layer capacitance of the electrode were measured and are shown in FIGS. 14 and 15, respectively.

The electrode for a carbon dioxide reduction reaction according to Example 1 included the triazine structure thin film and had the water contact angle of 100.30°, which was greatly increased as compared with 64.06° which was the water contact angle of the electrode for a carbon dioxide reduction reaction according to Comparative Example 1 and was confirmed to have a hydrophobic surface.

### Experimental Example 8-1

The surface water contact angle and the electric double layer capacitance of the electrodes for carbon dioxide reduction reaction according to Example 1 (trCOF-Cu) and Comparative Example 1 (Cu) were measured and are shown in FIGS. 14 and 15, respectively.

The electrode for a carbon dioxide reduction reaction according to Example 1 included the triazine structure thin film and had the water contact angle of 100.30°, which was greatly increased as compared with 64.06° which was the water contact angle of the electrode for a carbon dioxide reduction reaction according to Comparative Example 1 and was confirmed to have a hydrophobic surface.

In addition, it was confirmed that the electrode for a carbon dioxide reduction reaction according to Example 1 had a decreased electric double layer capacitance as compared with the electrode for a carbon dioxide reduction reaction according to Comparative Example 1. This means that the electrode for a carbon dioxide reduction reaction according to Example 1 included the triazine structure thin film and had a hydrophobic surface so that the active surface area of a copper surface was decreased, and thus, a hydrogen evolution reaction as a side reaction was able to be decreased and the production reaction of the multi-carbon compound was able to be increased.

### Experimental Example 9

While the electroreduction reaction of the carbon dioxide electroreduction system was carried out, real-time infrared absorption spectra of the surface of the electrodes for carbon dioxide reduction reaction according to Example 1 (trCOF-Cu) and Comparative Example 1 (Cu) were measured and the results are shown in FIG. 16.

Referring to FIG. 16, it was confirmed that the intensity of the O—H stretching vibration peak of water shown at 3400 cm-1 on the surface of the electrode for a carbon dioxide reduction reaction according to Example 1 while carrying out the electroreduction reaction was decreased as compared with the electrode for a carbon dioxide reduction reaction according to Comparative Example 1. This means that the number of active water molecules having high activity used in hydrogen evolution was decreased, and it is considered to be due to the increased hydrophobicity on the surface of the electrode by the triazine structure thin film.

### Experimental Example 10

The carbon dioxide adsorption capacity of the electrodes for carbon dioxide reduction reaction according to Example 1 (m-trCOF) and Comparative Example 1 (m-tr-free COF) was measured and is shown in FIG. 17. Referring to FIG. 17, it was confirmed that the carbon dioxide adsorption capacity of the electrode for a carbon dioxide reduction reaction according to Example 1 was higher than the carbon dioxide adsorption capacity of the electrode for a carbon dioxide reduction reaction according to Comparative Example 2.

### Experimental Example 11

The behaviors of carbon monoxide (Co) intermediates adsorbed on the surface of the electrodes for carbon dioxide reduction reaction according to Example 1 (trCOF-Cu) and Comparative Example 1 (Cu) were compared and analyzed by a real-time infrared absorption spectrum and is shown on the left (trCOF-Cu; Example 1) and right (Cu; Comparative Example 1) of FIG. 18.

In order to produce a multi-carbon compound, carbon monoxide (CO) which is an intermediate should exist close to each other to proceed with CO—CO coupling. Referring to FIG. 18, it was confirmed that a stretching vibration peak between carbon-oxygen of a carbon monoxide intermediate shown on the surface of the electrode for a carbon dioxide reduction reaction according to Example 1 showed a red shifted position and a higher integral value, as compared with Comparative Example 1. That is, it was confirmed that since the electrode for a carbon dioxide reduction reaction according to Example 1 included a triazine structure thin film, the carbon monoxide intermediate is more strongly adsorbed on a copper surface to increase concentration, which increased a probability of proceeding with CO—CO coupling, resulting in an increase in production efficiency of a multi-carbon compound.

### Experimental Example 12

Faradaic efficiency of each chemical species of a carbon dioxide electroreduction reaction carried out by a carbon dioxide reduction reaction system including the electrodes for carbon dioxide reduction reaction according to Example 1 (trCOF-Cu (t=4 nm)) and Example 2 (thick trCOF-Cu (t=27 nm)) is shown on the left (Example 1) and right (Example 2) of FIG. 19.

Referring to FIG. 19, it was confirmed that the carbon dioxide reduction reaction system including the electrode for a carbon dioxide reduction reaction according to Example 2 had further increased selectivity for methane and decreased selectivity for other multi-carbon compounds including ethylene, depending on the thickness of the triazine structure thin film. It was confirmed therefrom that as the triazine structure thin film was thickened, the carbon dioxide gas was adsorbed to the wall of the triazine structure thin film before approaching the copper electrode, so that the carbon dioxide concentration near the copper electrode was rather able to be decreased. Therefore, it was confirmed that the thickness of the triazine structure thin film was able to be variously adjusted depending on the selectivity of the multi-carbon compound.

The electrode for a carbon dioxide reduction reaction according to the present invention and the carbon dioxide electroreduction device using the same may have high multi-carbon compound selectivity and reactivity during a carbon dioxide reduction reaction and low side reaction selectivity.

The method for manufacturing an electrode for a carbon dioxide reduction reaction according to the present invention may produce an electrode having a large electrode by a simple method.

Hereinabove, although the present specification has been described by specified matters and specific exemplary embodiments, they have been provided only for assisting in the entire understanding of the present invention. Therefore, the present invention is not by the specific matters limited to the exemplary embodiments. Various modifications and changes may be made by those skilled in the art to which the present invention pertains from this description. Therefore, the spirit described in the present specification should not be limited to the above-described exemplary embodiments, and the following claims as well as all modified equally or equivalently to the claims are intended to fall within the scope and spirit of the specification.

1. A method for manufacturing an electrode for a carbon dioxide reduction reaction, the method comprising:
laminating a triazine structure thin film which is prepared by condensation polymerization of an amine-substituted triazine compound and an aldehyde compound on a copper substrate,
wherein the condensation polymerization is performed by light irradiation.

2. The method for manufacturing an electrode for a carbon dioxide reduction reaction of claim 1, wherein the triazine structure thin film is prepared by:
(S1) dropping a mixed solution including the amine-substituted triazine compound and the aldehyde compound onto a surface of a solvent to form a mixed solution film on the surface of the solvent; and
(S2) irradiating the mixed solution film with light to manufacture the triazine structure thin film.

3. The method for manufacturing an electrode for a carbon dioxide reduction reaction of claim 1, wherein the laminating is performed by transferring the triazine structure thin film placed on the surface of the solvent.

4. The method for manufacturing an electrode for a carbon dioxide reduction reaction of claim 1, wherein the amine-substituted triazine compound is a compound satisfying the following Chemical Formula 1: 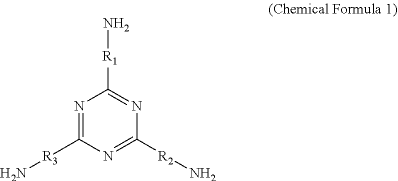
wherein R₁ to R₃ are independently of one another alkylene having 2 to 8 carbon atoms or arylene.

5. The method for manufacturing an electrode for a carbon dioxide reduction reaction of claim 1, wherein the amine-substituted triazine compound is 1,3,5-tris (4-aminophenyl)triazine.

6. The method for manufacturing an electrode for a carbon dioxide reduction reaction of claim 1, wherein the aldehyde compound satisfies the following Chemical Formula 2: 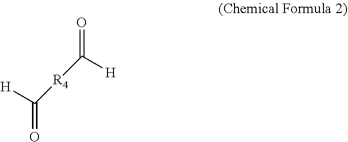
wherein R₄ is alkylene having 2 to 8 carbon atoms or arylene.

7. The method for manufacturing an electrode for a carbon dioxide reduction reaction of claim 6, wherein in Chemical formula 2, R₄ is phenylene.

8. The method for manufacturing an electrode for a carbon dioxide reduction reaction of claim 2, wherein the mixed solution of (S1) further includes acetic acid.

9. The method for manufacturing an electrode for a carbon dioxide reduction reaction of claim 2, wherein the light of (S2) has a wavelength band of 350 to 850 nm.

10. The method for manufacturing an electrode for a carbon dioxide reduction reaction of claim 1, wherein the triazine structure thin film has a thickness of 2 nm to 50 nm.

11. An electrode for a carbon dioxide reduction reaction manufactured by the method of claim 1.

12. The electrode for a carbon dioxide reduction reaction of claim 11, wherein a surface of the electrode for a carbon dioxide reduction reaction has a water contact angle of 90° or more.

13. A carbon dioxide electroreduction device comprising:
an electrode for a carbon dioxide reduction reaction manufactured by the method of claim 1;
an anion exchange membrane;
a counter electrode separated from the electrode for a carbon dioxide reduction reaction; and
an electrolyte,
wherein the anion exchange membrane is placed between the electrode for a carbon dioxide reduction reaction and the counter electrode, and
a multi-carbon compound is produced from carbon dioxide by the electroreduction reaction.

14. The carbon dioxide electroreduction device of claim 13, wherein the multi-carbon compound is one or more selected from the group consisting of ethylene, ethanol, and a combination thereof.

15. The carbon dioxide electroreduction device of claim 14, wherein the ethylene produced by the electroreduction reaction has a Faradaic efficiency (FE) of 20% or more at −1.1 V using a reversible hydrogen electrode (RHE) as a reference electrode.

16. The carbon dioxide electroreduction device of claim 13, wherein the Faradaic efficiency (FE) of hydrogen (H₂) produced by the electroreduction reaction may be 20% or less at −1.1 V using the reversible hydrogen electrode (RHE) as a reference electrode.
